(19) United States
(12) Patent Application Publication
(10) Pub. No.: US 2008/0316329 A1
(43) Pub. Date: Dec. 25, 2008

(54) CAMERA MODULE

(75) Inventors: Byung Hoon KIM, Suwon (KR); Won Tae Choi, Yongin (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/141,668

(22) Filed: Jun. 18, 2008

(30) Foreign Application Priority Data
Jun. 20, 2007 (KR) 10-2007-60556

(51) Int. Cl. H04N 5/228

(52) U.S. Cl. 348/222.1; 348/E05.031

(57) ABSTRACT

There is provided a camera module including: first and second image sensors having different optical characteristics and sensing images; first and second auxiliary image processors electrically connected to the first and second image sensors, respectively, and correcting optical defects of the images sensed by the first and second sensors, respectively; and an image signal processing section selecting at least one image between the images corrected by the first and second auxiliary image processors, and processing the selected image into an image signal that can be displayed, wherein at least one of the first and second image sensors may include: a center pixel array having a square shape; and first to fourth pixel arrays having one set of sides connected to sides of the center pixel array and having the same length as the sides of the center pixel array.

### CROSS-REFERENCE TO RELATED APPLICATIONS

This application claims the priority of Korean Patent Application No. 2007-0060556 filed on Jun. 20, 2007, in the Korean Intellectual Property Office, the disclosure of which is incorporated herein by reference.

### BACKGROUND OF THE INVENTION

1. Field of the Invention

The present invention relates to camera modules, and more particularly, to a camera module that can be reduced in size and has a camera module provided with an image sensor to display an image having a predetermined direction regardless of a slope of the image sensor.

2. Description of the Related Art

Recently, mobile communication service providers have implemented high speed downlink packet access (HSDPA) throughout a whole nation. The high speed downlink packet access enables video communication between one user and another user using mobile communication terminals, such as mobile phones and PDAs, while seeing each other face to face. In general, an image sensor for capturing an image that serves as a camera is provided in the mobile communication terminal. In order to perform the video communication, a separate image sensor for the video communication is provided in the mobile communication terminal. A camera module according to the related art that is provided in the mobile communication terminal will now be described with reference to the accompanying drawing.

FIG. 1 is a configuration view illustrating a camera module according to the related art.

Referring to FIG. 1, the camera module according to the related art includes a plurality of image sensors 11 and 12 and a plurality of image processors 21 and 22.

The plurality of image sensors 11 and 12 include the first image sensor 11 for general image capturing that is used to capture an image or store the captured image, and the second image sensor 12 for video communication that is used to perform the video communication.

In the same manner, the plurality of image processors 21 and 22 include the first image processor 21 that processes an electrical signal from the first image sensor 11 and generates an image signal, and the second image processor 22 that processes an electric signal from the second image sensor 12 and generates an image signal.

As described above, the camera module according to the related art includes the first and second image sensors 11 and 12 that are used for different purposes, and the first and second image processors 21 and 22 that process the electrical signals from the first and second image sensors 11 and 12, respectively, to generate the image signals.

However, when the camera module according to the related art is mounted to a board in the mobile communication terminal, the camera module occupies considerable space, which increases the volume of the mobile communication terminal. Further, a direction in which an image is displayed on a display screen is changed according to a slope of each of the image sensors.

### SUMMARY OF THE INVENTION

An aspect of the present invention provides a camera module that can be reduced in size and has a camera module provided with an image sensor to display an image having a predetermined direction regardless of a slope of the image sensor.

According to an aspect of the present invention, there is provided a camera module including: first and second image sensors having different optical characteristics and sensing images; first and second auxiliary image processors electrically connected to the first and second image sensors, respectively, and correcting optical defects of the images sensed by the first and second sensors, respectively; and an image signal processing section selecting at least one image between the images corrected by the first and second auxiliary image processors, and processing the selected image into an image signal that can be displayed, wherein at least one of the first and second image sensors may include: a center pixel array having a square shape; and first to fourth pixel arrays having one set of sides connected to sides of the center pixel array and having the same length as the sides of the center pixel array.

The first to fourth pixel arrays may have the same area and shape.

Each of the first to fourth pixel arrays may have an aspect ratio of 6:1 between a side contacting the center pixel array and a side perpendicular to the side.

The first image sensor may be an image-capturing image sensor, and the second image sensor may be a video-communication image sensor.

The image signal processing section may include: a selector selecting one corrected image between the images corrected by the first and second auxiliary image processors according to a control signal; and a main signal processor processing the corrected image selected by the selector into the image signal.

The camera module may further include first and second lenses having different optical characteristics and connected to the first and second image sensors, respectively.

The camera module may further include color filters connected to the first and second lenses, filtering the images from the first and second lenses by predetermined colors, and transmitting the filtered images to the first and second image sensors, respectively.

Each of the first and second auxiliary image processors may correct the shade of the image.

Each of the first and second auxiliary image processors may correct a dead pixel of the image among the optical defects of the image.

The first image sensor and the first auxiliary image processor may be formed in a first IC, and

the second image sensor and the second auxiliary image processor may be formed in a second IC.

The camera module may further include a board having one surface and the other surface opposing the one surface, wherein the first IC is mounted to the one surface of the board, the second IC is mounted to the other surface of the board, and the image signal processing section is mounted to the one surface or the other surface of the board.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration view illustrating a camera module according to the related art;

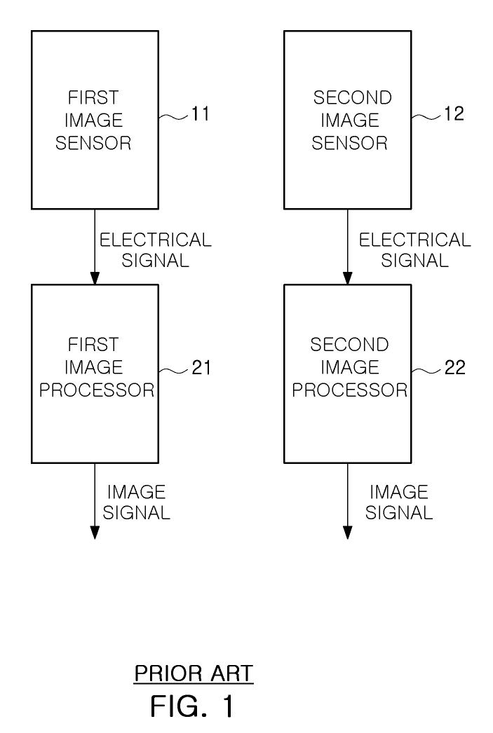

FIG. 2 is a configuration view illustrating a configuration illustrating a camera module according to an exemplary embodiment of the present invention;

FIG. 3 is a view illustrating a pixel array of an image sensor that is used in a camera module according to an exemplary embodiment of the present invention;

FIGS. 4A to 4C is a view illustrating a structure of a pixel array selected in the image sensor according to the embodiment of the present invention; and

FIG. 5 is a configuration view illustrating a camera module according to an exemplary embodiment.

### DETAILED DESCRIPTION OF THE PREFERRED EMBODIMENT

Exemplary embodiments of the present invention will now be described in detail with reference to the accompanying drawings.

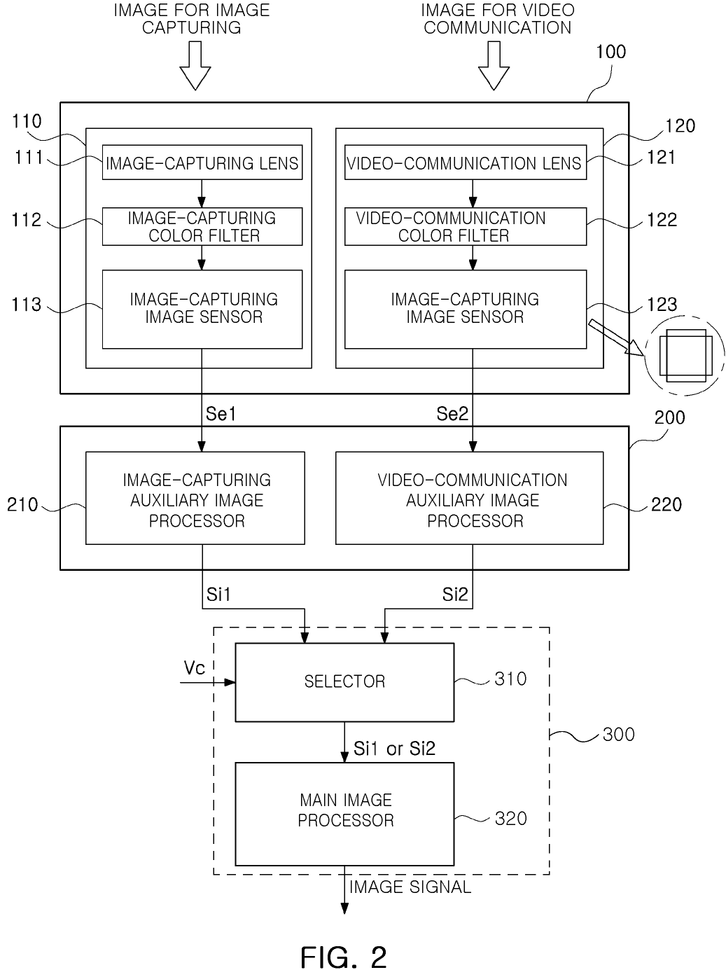

FIG. 2 is a configuration view illustrating a camera module according to an exemplary embodiment of the present invention.

Referring to FIG. 2, the camera module according to the embodiment of the invention may include an image sensor section 100, an auxiliary image processing section 200, and an image signal processing section 300.

The first image sensor section 100 may include a plurality of image sensor units 110 and 120. In this embodiment, the first image sensor unit 110 is an image sensor unit for image capturing (hereinafter, referred to as an “image-capturing image sensor unit”), and the second image sensor unit 120 is an image sensor for video communication (hereinafter, referred to as a “video-communication image sensor unit”).

The first and second image sensor units 110 and 120 may include first and second lenses 111 and 121, first and second color filters 112 and 122, and first and second image sensors 113 and 123, respectively.

The first and second lenses 111 and 121 have different optical characteristics from each other, and are individually used to capture different images. In this embodiment, the first lens 111 may be a lens for image capturing (hereinafter, referred to as an “image-capturing lens”), and the second lens 121 may be a lens for video communication.

As described above, the image-capturing lens 111 and the video-communication lens 112 have different optical characteristics, such as an angle of view, curvature of the lens surface, and the like. Thus, images captured through the lenses 111 and 112 may have different color information, such as color and color tones.

The images captured through the first and second lenses 111 and 112 may be transmitted to the first and second image sensors 113 and 123, respectively, corresponding to the image-capturing lens 111 and the video-communication lens 112.

In this embodiment, the first image sensor 113 may be an image sensor for image capturing (hereinafter, referred to as an “image-capturing image sensor”), and the second image sensor 123 may be an image sensor for video communication (hereinafter, referred to as a “video-communication image sensor”).

As described above, the image-capturing image sensor 113 and the video-communication image sensor 123 have the different optical characteristics from each other. For example, the image-capturing image sensor 113 may contain 1.3 million pixels or 2 million pixels. The video-communication image sensor 123 may be a CIF (Common Intermediate Format), QCIF (Quarter Common Intermediate Format), or VGA (Video Graphics Array) image sensor containing twenty five thousand pixels. Further, a resolution of the image-capturing image sensor 113 may be higher than that of the video-communication image sensor 123.

In this embodiment, each of the image sensors 113 and 123 includes a cross-shaped pixel array.

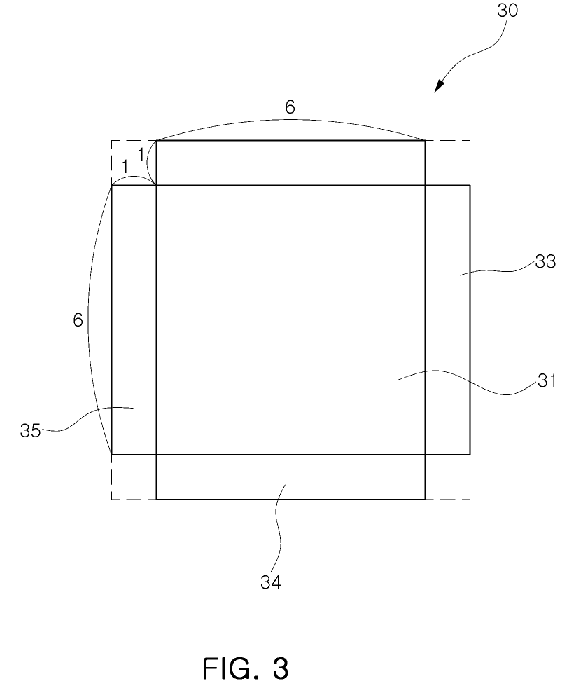

The shape of the pixel array of each of the image sensors will be described in detail with reference to FIG. 3.

The first color filter 112 corresponding to the first lens 111 and the first image sensor 113 may be connected between the first lens 111 and the first image sensor 113. The second color filter 122 corresponding to the second lens 121 and the second image sensor 123 may be connected between the second lens 121 and the second image sensor 123. The first and second color filters 112 and 122 filter the images transmitted from the first and second corresponding lenses 111 and 121, respectively, by predetermined colors.

As the mobile communication providers implement high speed downlink packet access (HSDPA), the image sensor section 100 performs an image capturing function and a video communication function. When the image capturing function is performed, an image is captured, and the captured image is stored. When the video communication function is performed, an image is captured, and the captured image is used for video communication. In this embodiment, the first image sensor unit 110 may perform the image capturing function, and the second image sensor unit 120 may perform the video communication function.

Electrical signals Se1 and Se2 are transmitted to the auxiliary image processing section 200 from the image-capturing image sensor 113 and the video-communication image sensor 123. The electrical signals Se1 and Se2 include image-capturing image information and video-communication image information, respectively.

Each of the image-capturing lens 111 and the video-communication lens 121 may suffer optical defects when capturing an image. Each of the image-capturing image sensor 113 and the video-communication image sensor 123 may also have optical defects.

Examples of the optical defects of the image-capturing lens 111 and the video-communication lens 121 may include defects related to color and the like. In the image-capturing image sensor 113 and the video-communication image sensor 123, pixels may not physically perform normal functions.

The image information included in the electrical signal Se1 and the image information included in the electrical signal Se2 are transmitted from the image-capturing image sensor 113 and the video-communication image sensor 123, respectively. Each image information may have color information and pixel information having different optical defects from each other. Thus, the camera module according to this embodiment may necessarily include auxiliary image processors that individually correct different optical defects from each other.

The auxiliary image processing section 200 includes a plurality of auxiliary image processors 210 and 220. The auxiliary image processors 210 and 220 may be an auxiliary image processor for image capturing (hereinafter, referred to as an “image-capturing auxiliary image processor”) and an auxiliary image processor for video communication (hereinafter, referred to as a “video-communication auxiliary image processor”), respectively.

The first electrical signal Se1 is transmitted to the image-capturing auxiliary image processor 210 from the image-capturing image sensor 113. The second electrical signal Se2 is transmitted to the video-communication auxiliary image processor 220 from the video-communication image sensor 123.

As described above, the first electrical signal Se1 may include the image information about an image captured for image capturing, the color information of the image-capturing lens 111, and the pixel information of the image-capturing image sensor 113. In the same manner, the second electrical signal Se2 may include the image information about an image captured for video communication, the color information of the video-communication lens 121, and the pixel information of the video-communication image sensor 123.

Here, the image-capturing auxiliary image processor 210 can correct the optical defects of the image-capturing lens 111 and the image-capturing image sensor 113 from the information included in the first electrical signal Se1. That is, the image-capturing auxiliary image processor 210 can correct the shade of color included in the color information of the image-capturing lens 111, and dead pixels included in the pixel information of the image-capturing image sensor 113.

In the same manner, the video-communication auxiliary image processor 220 can correct the color information of the video-communication lens 121 and the pixel information of the video-communication image sensor 123 that are included in the second electrical signal Se2. That is, the video-communication auxiliary image processor 220 corrects the shade of color included in the color information of the video-communication lens 121, and dead pixels included in the pixel information of the video-communication image sensor 123.

The image-capturing auxiliary image processor 210 may transmit to the image signal processing section 300, a first image signal si1 that includes the corrected color information, the corrected pixel information, and the image information about the image for image capturing. In the same manner, the video-communication auxiliary image processor 220 may transmit to the image signal processing section 300, a second image signal Si2 that includes the corrected color information, the corrected pixel information, and the image information about the image for video communication.

The image signal processing section 300 receives and processes the first and second image signals Si1 and Si2 from the image-capturing auxiliary image processor 210 and the video-communication auxiliary image processor 220, respectively, to generate signals that can be displayed. The image signal processing section 300 processes the corrected color information, the corrected pixel information, and the image information. The image signal processing section 300 performs the signal processing. The image signal processing section 300 includes such functions as color interpolation in which original color of an image being captured is achieved by using ambient color, color correction in which color difference of an image being captured is corrected, gamma conversion in which nonlinear characteristics of color of an image being captured is converted into linear characteristics, auto exposure in which light intensity of an image being captured is controlled, auto focus in which focus of an image being captured is adjusted, and auto white balance in which difference in color temperature of an image being captured is corrected.

The image signal processing section 300 selects any one image signal between the first and second image signals Si1 and Si2 that are transmitted from the image-capturing auxiliary image processor 210 and the video-communication auxiliary image processor 220, respectively. Then, the image signal processing section 300 processes the color information, the corrected pixel information, and the image information that are included in the selected image signal.

Correspondingly, the image signal processing section 300 may include a selector 310 and a main signal processor 320. The selector 310 selects one image signal between the first and second image signals Si1 and Si2 from the auxiliary image processing section 200 according to a control signal Sc. The main signal processor 320 receives the image signal from the selector 310 and performs the signal processing of the image signal processing section 300. When the image capturing function or the video communication function is selected through a keypad of a mobile communication terminal to which the camera module according to the embodiment of the invention is mounted, the control signal Sc may be transmitted to the selector 310.

FIG. 3 is a view illustrating a cross-shaped pixel array that is used in a camera module according to the exemplary embodiment of the present invention. A pixel array of the image sensor may be applied to one or both of the image-capturing image sensor 113 and the video-communication image sensor 123 among the components shown in FIG. 2.

Referring to FIG. 3, the pixel array of the image sensor according to the embodiment of the invention may include a center pixel array 31, and first to fourth pixel arrays 32, 33, 34, and 35 connected to the center pixel array 31.

Pixels in the center pixel array 31 may be arrayed in a square.

Pixels of each of the first to fourth pixel arrays 32, 33, 34, and 35 may be arrayed in a rectangle. One set of sides of the first to fourth pixel arrays 32, 33, 34, and 35 may contact four sides of the center pixel array 31. A length of each one side of the first to fourth pixel arrays 32, 33, 34, and 35 may be equal to that of one side of the center pixel array 31.

The first to fourth pixel arrays 32, 33, 34, and 35 may have the same shape and area.

Each of the first to fourth pixel arrays 32, 33, 34, and 35 has one side contacting the side of the center pixel array 31, and another side perpendicular thereto at a ratio of 6:1.

When the pixels are arrayed to have the aspect ratio, the center pixel array 31, the first pixel array 32, and the third pixel array 34 may configure a vertical image sensor having a 3:4 aspect ratio. Further, the center pixel array 31, the second pixel array 33, and the fourth pixel array 35 may configure a horizontal image sensor having a 4:3 aspect ratio.

When the image sensor is mounted to the mobile communication terminal, the mobile communication terminal needs to be inclined by about 90 degrees to capture an image or the image sensor only needs to be inclined. Here, a slope of the image sensor indicates a slope of the image sensor with respect to a predetermined reference direction on an XY-plane.

In this case, since a pixel (s) from which the image sensor starts to scan an object to generate an image signal and a scanning direction are determined, when the image sensor directly reads out the image signal, the image is also inclined at the slope of the image sensor and displayed on a screen of a display. Further, in order to prevent the inclination of the image displayed on the screen of the display, if a reception unit rotates the image on the screen one more time, the image may be scaled down or both edges of the image may be cut off.

In this embodiment, as described above, in order to correct the slope of the image on the display screen that operates according to the slope of the image sensor, the image sensor may have an aspect ratio of a 4:3 and an aspect ratio or a 3:4 aspect ratio according to the slope of the image sensor.

That is, when the display screen an aspect ratio of 4:3, if the image sensor 30 has a slope of zero, the center pixel array 31, the second pixel array 33, and the fourth pixel array 35 are selected so that the image sensor 30 has an aspect ratio of 4:3. When the image sensor 30 has a slope of 90 degrees, the center pixel array 31, the first pixel array 32, and the third pixel array 34 are selected so that the image sensor 30 has an aspect ratio of 3:4.

In this way, the arrangement of the pixel array of the image sensor 30 can be determined, such that an aspect ratio of an image being displayed can be constantly maintained regardless of the slope of the image sensor 30.

In order to determine the slope of the image sensor, a slope sensor that can determine a slope of the image sensor with respect to the reference direction on an XY-plane may be mounted in connection with the image sensor 30. Further, the user can select an aspect ratio of the image sensor 30 according to the slope of the image sensor 30 by using a key button mounted onto the mobile communication terminal.

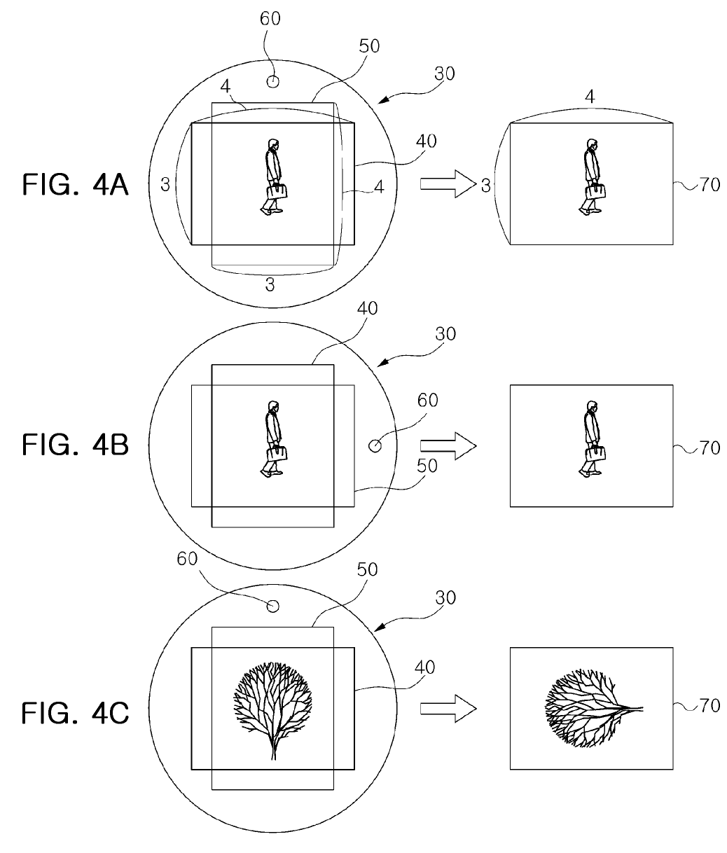

FIGS. 4A to 4C are views illustrating a pixel array of an image sensor that operates according to a slope of the image sensor according to an exemplary embodiment of the present invention. In this embodiment, a slope sensor 60 may be mounted to sense the slope of the image sensor 30.

In FIG. 4A, when the image sensor 30 has a slope of zero degree relative to the reference direction on the XY-plane, a horizontal image sensor 40 is selected. Therefore, the image sensor 30 has the aspect ratio of 4:3, and a screen 70 that displays the captured image has the same aspect ratio of 4:3. As a result, a direction of an object that is sensed by the image sensor 30 and a direction in which the image of the object is displayed may be the same as each other.

In FIG. 4B, when the image sensor 30 has a slope of 90 degrees relative to the predetermined reference direction on the XY-plane, a vertical image sensor 50 may be selected. Therefore, the image sensor has an aspect ratio of 4:3, and the screen 70 that displays the captured image has the same aspect ratio of 4:3. As a result, a direction of the object sensed by the image sensor 30 and a direction in which the image of the object is displayed on the screen 70 may be the same as each other.

In this way, a mechanism in which the slope of the image sensor is detected, and the arrangement of the pixel array is determined according to the slope of the image sensor can be variously implemented. That is, a method of determining the slope of the image sensor may include using a slope sensor or a causing a user to use key buttons of the mobile communication terminal.

In FIG. 4C, when the image sensor 30 has a slope of zero degree relative to the predetermined reference direction on the XY-plane, the vertical image sensor 50 can be selected.

In order to capture an object having a larger height than a width, the image sensor or a mobile communication terminal having the image sensor therein needs to be inclined. In this case, in this embodiment, the arrangement of the pixel array is changed such that there is no use to incline the image sensor or the mobile communication terminal having the image sensor therein.

However, in this case, the image sensor 30 has an aspect ratio of 3:4, and the screen 70 has the aspect ratio of the 4:3, the image of the object is rotated by −90 degrees relative to the direction of the object sensed by the image sensor 30, and the rotated image is displayed on the screen 70. Alternatively, the image may be displayed on the screen 70 in the same direction of the image sensor while no image is displayed on both edges of the screen 70.

As described above, since the arrangement of the pixel array of the image sensor 30 can be selected regardless of the slope of the image sensor. This is very advantageous particularly when it is difficult to incline the mobile communication terminal having the image sensor 30 thereon to capture an image.

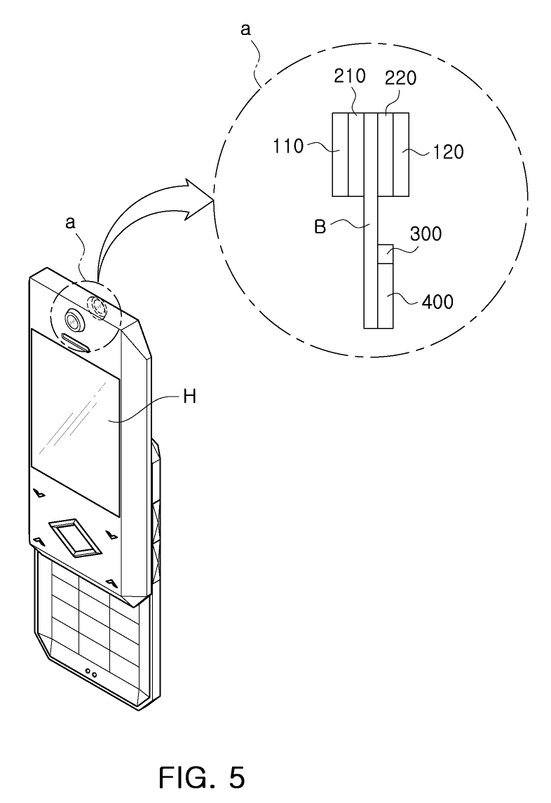

FIG. 5 is a view illustrating a camera module according to an exemplary embodiment of the present invention.

Referring to FIG. 5, the camera module according to the embodiment of the invention may be mounted to a mobile communication terminal. The mobile communication terminal having the camera module thereon is shown in a lower part of FIG. 5. In the mobile communication terminal, a video-communication image sensor may be located at an upper end of a front face on which an LCD display window is located so that a user captures a self-image and transmits the captured image to another user. Further, an image-capturing image sensor may be located at an upper end of a face opposing the front face.

An enlarged perspective view of a part (a) of the mobile communication terminal, where the camera module according to the embodiment of the invention is mounted, is shown in an upper part of FIG. 5. Referring to the enlarged perspective view of the upper part of FIG. 5, the camera module according to the embodiment of the invention may be formed on a board B. The board B has one surface and the other surface opposite to the one surface. The image-capturing image sensor unit 110 and the image-capturing auxiliary image processor 210 may be mounted to the one surface of the board B. A video-communication image sensor unit 120 and a video-communication auxiliary image processor 220 are mounted to the other surface of the board B.

The image-capturing image sensor unit 110 and an image-capturing auxiliary image processor 210 may be formed in one integrated circuit (IC). In the same manner, the video-communication image sensor unit 120 and the video-communication auxiliary image processor 220 may be formed in another IC. The selector 310 and the main image processor 320 may be mounted to the one surface or the other surface of the board B.

As set forth above, according to the exemplary embodiments of the invention, since auxiliary image processors that individually process color information and pixel information of lenses having different optical characteristics and image sensors having different pixel characteristics are provided to reduce a module size. Further, since an image sensor has a cross-shaped pixel array, an image having a constant direction can be displayed regardless of a slope of the image sensor.

While the present invention has been shown and described in connection with the exemplary embodiments, it will be apparent to those skilled in the art that modifications and variations can be made without departing from the spirit and scope of the invention as defined by the appended claims.

What is claimed is:

1. A camera module comprising:
first and second image sensors having different optical characteristics and sensing images;
first and second auxiliary image processors electrically connected to the first and second image sensors, respectively, and correcting optical defects of the images sensed by the first and second sensors, respectively; and
an image signal processing section selecting at least one image between the images corrected by the first and second auxiliary image processors, and processing the selected image into an image signal that can be displayed,
wherein at least one of the first and second image sensors comprises:
a center pixel array having a square shape; and
first to fourth pixel arrays having one set of sides connected to sides of the center pixel array and having the same length as the sides of the center pixel array.

2. The camera module of claim 1, wherein the first to fourth pixel arrays have the same area and shape.

3. The camera module of claim 2, wherein each of the first to fourth pixel arrays has an aspect ratio of 6:1 between a side contacting the center pixel array and a side perpendicular to the side.

4. The camera module of claim 1, wherein the first image sensor is an image-capturing image sensor, and
the second image sensor is a video-communication image sensor.

5. The camera module of claim 1, wherein the image signal processing section comprises:
a selector selecting one corrected image between the images corrected by the first and second auxiliary image processors according to a control signal; and
a main signal processor processing the corrected image selected by the selector into the image signal.

6. The camera module of claim 1, further comprising:
first and second lenses having different optical characteristics and connected to the first and second image sensors, respectively.

7. The camera module of claim 6, further comprising:
color filters connected to the first and second lenses, filtering the images from the first and second lenses by predetermined colors, and transmitting the filtered images to the first and second image sensors, respectively.

8. The camera module of claim of claim 1, wherein each of the first and second auxiliary image processors corrects the shade of the image.

9. The camera module of claim 8, wherein each of the first and second auxiliary image processors corrects a dead pixel of the image among the optical defects of the image.

10. The camera module of claim 1, wherein the first image sensor and the first auxiliary image processor are formed in a first IC, and
the second image sensor and the second auxiliary image processor are formed in a second IC.

11. The camera module of claim 10, further comprising:
a board having one surface and the other surface opposing the one surface,
wherein the first IC is mounted to the one surface of the board,
the second IC is mounted to the other surface of the board, and
the image signal processing section is mounted to the one surface or the other surface of the board.
